(19) United States
(12) Patent Application Publication
(10) Pub. No.: US 2008/0165200 A1
(43) Pub. Date: Jul. 10, 2008

(54) Hardware Background Tile Generation

(76) Inventors: Raymond Chow, Richmond (CA); Yun Shon Low, Richmond (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/620,521

(22) Filed: Jan. 5, 2007

(51) Int. Cl. G09G 5/39

(52) U.S. Cl. 345/531

(57) ABSTRACT

A graphics controller for animating a tiled background is described. The graphics controller includes a host interface for communicating with an external host CPU and a plurality of registers in communication with the host interface. Logic circuitry is configured to select between tile image data and main image data when passing pixel values to a display controller. The logic responds to values stored in the registers to for positioning the main image within the display. A method carried out by the graphics controller and a method for using the graphics controller are also described.

### BACKGROUND

Battery operated devices having a graphical display are increasingly popular. Cell phones, MP3 players, global positioning satellite (GPS) receivers, personal data assistants, and hand-held video games, are a few examples of such devices incorporating a graphical display made up of a two-dimensional matrix of pixels.

As more such devices enter the market, it is increasingly important to provide increased capability and functionality to provide distinguishing characteristics. Unfortunately, many functional improvements require increased computer processing, which adversely affects power consumption and battery life. It would therefore be desirable to provide enhanced functionality without significantly impacting battery performance.

In the field of computer graphical displays, it is known to tile a background image to create a mosaic or textured background over which other text or graphical content or text may be provided. Painting the background image requires that the host central processing unit (CPU) composite the foreground information with the tiled background, and then paint the entire display area with the composite image. This requires a significant number of host CPU cycles to accomplish. Furthermore, if scrolling of the background image is required, the host CPU is forced to recomposite and repaint the image each frame or “n” number of frames as required. Such operations would use significant processor bandwidth and battery power, which could shorten battery life. It would therefore be desirable to provide a capability for static or dynamic tiled background without utilizing significant processor time.

### SUMMARY

Broadly speaking, the present invention fills these needs by providing a graphics controller for generating a composite image having a main image overlying a tiled background image.

It should be appreciated that the present invention can be implemented in numerous ways, including as a process, an apparatus, a system, a device, or a method. Several inventive embodiments of the present invention are described below.

In one embodiment, a graphics controller for animating an tiled background is provided. The graphics controller includes a host interface for communicating with an external processor and a plurality of registers in communication with the host interface. Logic circuitry is configured to select between tile image data and main image data when passing pixel values to a display controller. The logic responds to values stored in the registers to for positioning the main image within the display.

In another embodiment, a hardware-implemented method for generating a composite image from a main image and a tile image is provided. The method includes receiving tile image data into an image buffer, receiving main image data into the image buffer, receiving register values into a plurality of registers, determining whether a pixel to be painted to a display screen should be taken from the tile image data or the main image data, and passing one of the tile image pixel values from the tile image data to the display screen. The tile image data comprises a plurality of tile image pixel values that define a tile image. The main image data comprises a plurality of main image pixel values defining a main image. The determination of whether the pixel to be painted to the display screen should be taken from the tile image data or the main image data is based at least in part on the register values. When the pixel to be painted should be taken from the tile image data, the tile image pixel value is selected so that multiple copies of the tile image is generated in the display screen from the tile image data. When the pixel to be painted should be taken from the main image data, one of the main image pixel values from main image data is passed to the display screen.

In yet another embodiment, a method for causing a graphical controller to composite a main image over a tiled background image is provided. The method includes writing tile image data to a frame buffer of the graphical controller, writing to registers of the graphical controllers, and writing a value to an enable register. The registers define a display mode and image parameters. The value written to the enable register causes the graphical controller to generate the tiled background image by repeating a tile image defined by the tile image data.

The advantages of the present invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is an illustration showing by way of example a high-level architecture for a device capable of displaying graphical information.

FIG. 2 shows an exemplary display screen having a main image composited with a tiled background image.

FIG. 3 shows a tile image represented as a matrix of numbered pixels.

FIG. 4 shows a composite image formed from multiple copies of the tile image of FIG. 3 and an overlying main image.

FIG. 5 shows the composite image of FIG. 4 wherein the tiled background image is offset from the origin at the upper left corner of the display screen.

FIG. 6 shows a block diagram conceptually presenting by way of example operational blocks of graphics controller.

FIG. 7A shows an exemplary frame buffer for storing a main image and a tile image.

FIG. 7B shows a composite image formed from the main image and tile image stored in the frame buffer of FIG. 7A.

FIG. 8 shows a flowchart diagram illustrating by way of example a procedure for causing a tiled background to be generated by the graphics controller shown in FIG. 6.

FIG. 9 shows a simplified block diagram illustrating by way of example a hardware configuration for the memory controller shown in FIG. 6.

FIG. 10 shows a flowchart illustrating in simplified terms the operation of the logic block in FIG. 9.

FIG. 11 shows a flowchart illustrating by way of example a procedure carried out by display interface of FIG. 6.

### DETAILED DESCRIPTION

In the following description, numerous specific details are set forth in order to provide a thorough understanding of the present invention. However, it will be apparent to those skilled in the art that the present invention may be practiced without some of these specific details. In other instances, well known process operations and implementation details have not been described in detail in order to avoid unnecessarily obscuring the invention.

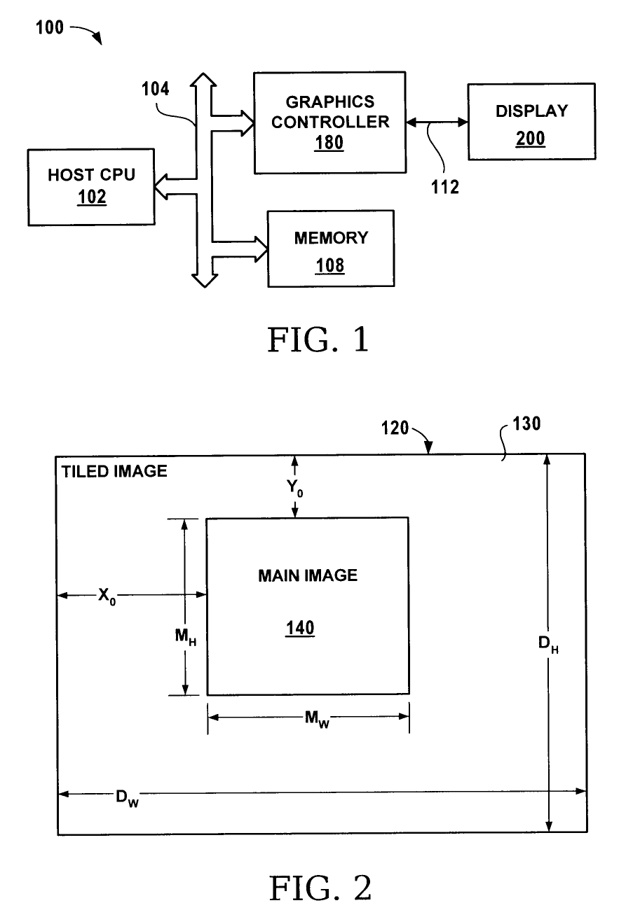

FIG. 1 is an illustration showing a high-level architecture of a device 100 for displaying graphical information. The device includes a host central processing unit (CPU) 102 in communication with a graphics controller 180 and memory 108 over a bus 104. The graphics controller 180 provides an interface between host CPU 102 and display 200.

The timing control signals and data lines between graphics controller 180 and display 200 are shown generally as line 112. These may in fact be several separate address, data and control lines but are shown generally as line 112, which may be referred to as a bus. It should be recognized that such data pathways may represented throughout the figures as a single line. Host CPU 102 performs digital processing operations and communicates with graphics controller 180 and memory 108 over bus 104. In other embodiments, host CPU 102 communicates over several address, data, and control lines.

In addition to the components mentioned above and illustrated in FIG. 1, those skilled in the art will recognize that there may be many other components incorporated into device 100, consistent with the application. For example, if device 100 is a cell phone, then wireless network interface, random access memory (RAM), digital-to-analog and analog-to-digital converters, amplifiers, keypad input, and so forth will be provided. Likewise, if device 100 is a personal data assistant (PDA), various hardware elements consistent with providing a PDA will be included in device 100. It will therefore be understood that FIG. 1 is not intended to be limiting, but rather to present those components directly related to novel aspects of the device.

Host CPU 102 performs digital processing operations and communicates with graphics controller 180. In one embodiment, host CPU 102 comprises an integrated circuit capable of executing instructions retrieved from memory 108. These instructions provide device 100 with functionality when executed on host CPU 102. Host CPU 102 may also be a digital signal processor (DSP) or other processing device.

Memory 108 may be internal or external random-access memory or non-volatile memory. Memory 108 may be non-removable memory such as flash memory or other EEPROM, or magnetic media. Alternatively, memory 108 may take the form of a removable memory card such as ones widely available and sold under such trademarks as “SD Card,” “Compact Flash,” and “Memory Stick.” Memory 108 may also be any other type of machine-readable removable or non-removable media. Memory 108 may be remote from device 100. For example, memory 108 may be connected to device 100 via a communications port (not shown), where a BLUETOOTH® interface or an IEEE 802.11 interface, commonly referred to as “Wi-Fi,” is included. Such an interface may connect imaging device 100 with a host (not shown) for transmitting data to and from the host. If device 100 is a communications device such as a cell phone, it may include a wireless communications link to a carrier, which may then store data in hard drives as a service to customers, or transmit data to another cell phone or email address. Memory 108 may be a combination of memories. For example, it may include both a removable memory card for storing image data, and a non-removable memory for storing data and software executed by host CPU 102.

Display 200 can be any form of display capable of displaying a digital image. In one embodiment, display 200 comprises a liquid crystal display (LCD). However, other types of displays are available or may become available that are capable of displaying an image that may be used in conjunction with device 100.

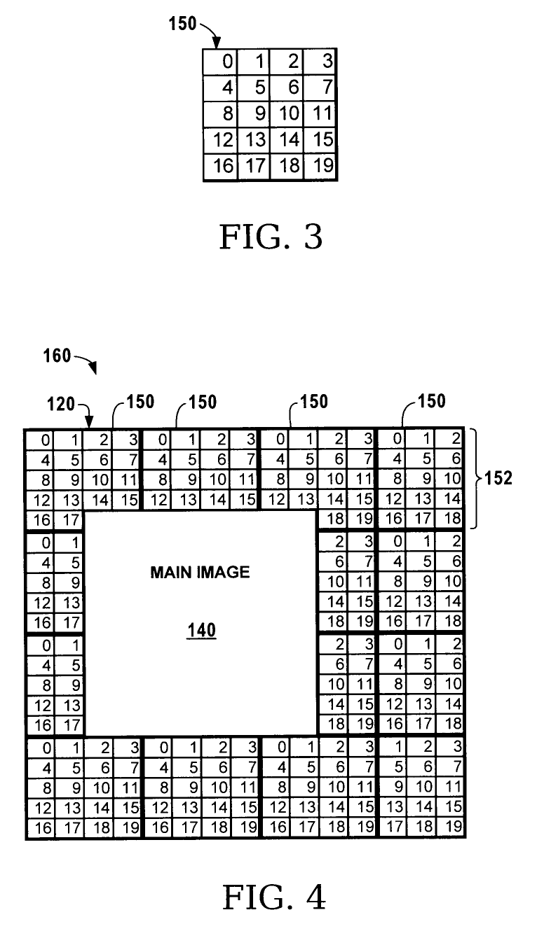

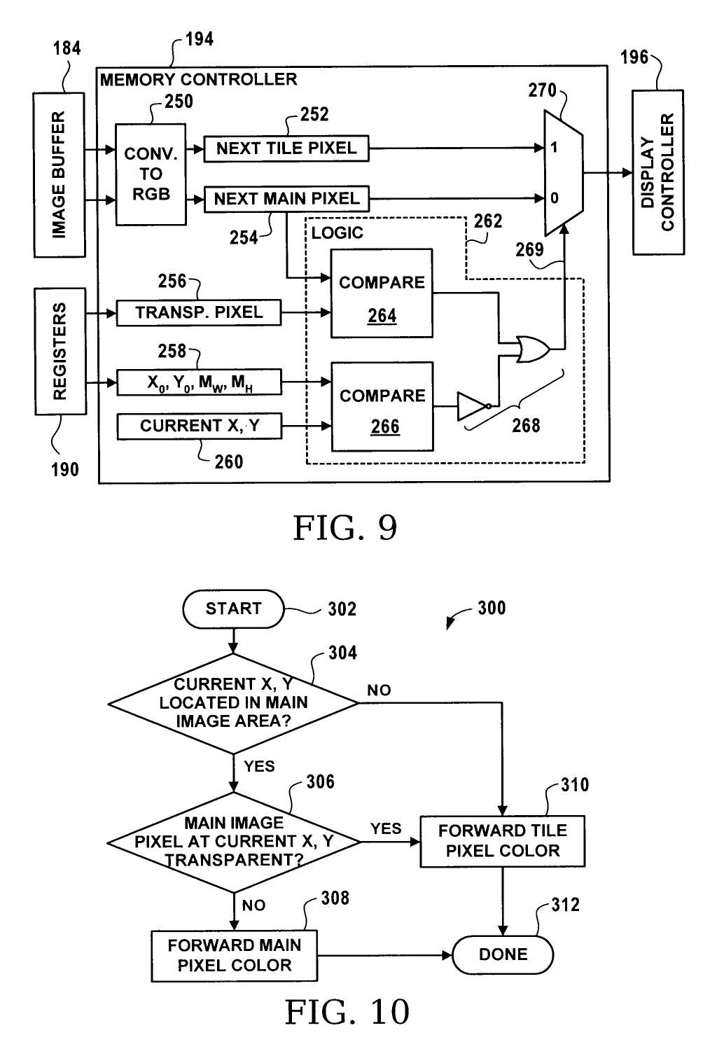

FIG. 2 shows an exemplary display screen 120 having a width D_{W} and a height D_{H}. For purposes of illustration, display screen 120 shows a main image 140 composited with a background image 130. In one embodiment, background image 130 is formed from a repeating tile image as described in more detail below with reference to FIGS. 3 and 4. In this example, main image 140 has a width of M_{W} pixels and a height of M_{H} pixels. For example, if M_{W} is 60 and M_{H} is 40, then main image 140 is 60 pixels wide and 40 pixels tall. Main image 140 may smaller than or the same size as display 120. In one embodiment, the position of main image 140 within display screen 120 is determined by the Main image offset values X₀ and Y₀, wherein X₀ is distance in pixels from the left edge of display screen 120 to the left edge of the main image 140 and Y₀ is the distance in pixels from the top of display screen 120 to the top of main image 140. Those skilled in the art will understand that a different convention can be used for positioning main image 140 within display screen 120 and that the origin of the Cartesian coordinate system used can be placed at a location other than the upper left corner of display screen 120. Main image 140 can be the same size or larger than display screen 120. If main image 140 is the same size as display screen 120, then it can be positioned to completely fill the display screen 120 by setting (X₀,Y₀) to (0,0). Any portion of main image 140 lying outside the area of display screen 120 can be cropped. In cases where main image 140 is larger than display screen 120, it can be scaled or resized to fit within the border of display screen 120 in a manner that will be further described below with reference to FIG. 9.

FIG. 3 shows an exemplary tile image 150 represented as a matrix of numbered pixels. Tile image 150 is four pixels wide and five pixels tall, and has 20 pixels numbered 0 through 19. Of course, tile images can be arbitrarily sized, and tile image 150 is presented purely as an example for illustrative purposes. Each pixel of tile image 150 can be assigned a unique numerical value, referred to herein as a pixel value, that represents a color to be displayed at that position relative to tile image 150. In one embodiment, the color can be represented in various formats, such as RGB. The RGB value can have varying bits per pixel (BPP) according to a BPP mode. Thus in a BPP mode referred to as rgb332, red intensity is defined by the first three bits of the pixel value, the green is defined by the next three bits of the pixel value, and the blue intensity is defined by the last two bits of the pixel value, for a total of 8 bits per pixel. Other BPP modes are known such as rgb565. In another embodiment, the color can be represented in YUV format, which defines a color in terms of a luminance value and two chrominance values in a manner that is well understood in the art. In yet another embodiment, image data may be stored in a compressed format such as JPEG or other compressed format.

FIG. 4 shows a composite image 160 formed from tile image 150 and main image 140. Tile image 150 is repeated in a mosaic to create a tiled background image that completely fills display screen 120. In one embodiment, display screen 120 is filled by placing a first tile image 150 in an upper left corner of display screen 120, and then repeating tile image 150 by placing subsequent copies of tile image 150 to the right of the first tile image, to create a first row 152 of tile images, then adding subsequent rows until display screen 120 is filled. Right most tile images and bottom-most tile images may be cropped as shown if they extend past the right and bottom edges of the display screen 120.

Main image 140 comprises a matrix of pixels, each of which has a pixel value that determines its color in the same manner as described above with reference to FIG. 3. In one embodiment, a specific pixel value can be designated as a “transparent” color. In this embodiment, when graphics controller 180 (FIG. 1) encounters a pixel having a the transparent color, it will pass a pixel value from the underlying tile image 150 instead of the main image 140. An exemplary mechanism to carry out this operation is described in more detail below with reference to FIGS. 9 and 10.

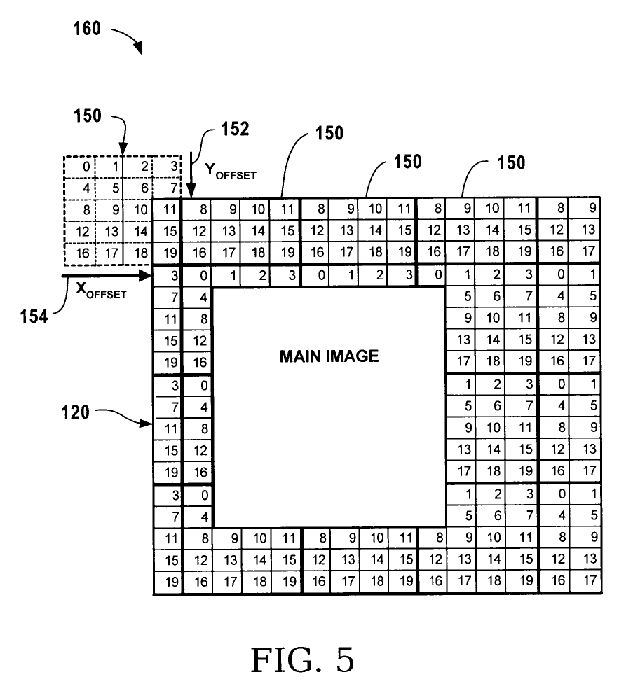

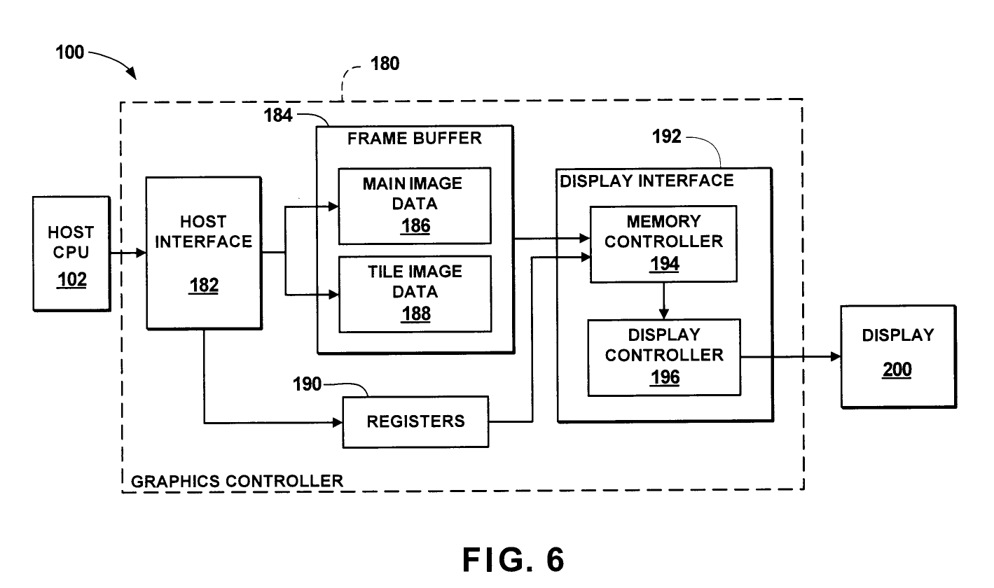

In FIG. 5, composite image 160 is composited from tile image 150 and main image 140, with tile image 150 repeated to form a tiled background image that is offset from the origin at the upper left corner of display screen 120 by an amount (X_{OFFSET}, Y_{OFFSET}). In one embodiment, X_{OFFSET} and Y_{OFFSET} are user definable, that is, they are programmable so that a full tile is not required to be aligned in upper left corner. In one embodiment, X_{OFFSET} and Y_{OFFSET} can be programmed to be automatically periodically updated to animate the background image 130 (FIG. 2). In this way, main image 140, which may be stationary, may appear to fly over the tiled background as it moves beneath the main image. A procedure and mechanism for animating the tiled background in this manner is described by way of example in more detail below with reference to FIGS. 6, 8, 9, and 11.

FIG. 6 shows a block diagram conceptually presenting by way of example operational blocks of graphics controller 180. It should be noted that in at least one embodiment, graphics controller 180 is an electronic device including logic that may, for example, be implemented in an application-specific integrated circuit (ASIC), a field programmable gate array (FPGA), or otherwise implemented in hardware. Therefore, in exemplary embodiments, graphics controller 180 comprises logic formed from logic gates, and does not require software instructions to operate. Host CPU 102 is in communication with host interface 182, which receives data and address information and passes the information to the appropriate locations in graphics controller 180. Frame buffer 184 includes an area for main image data 186 for describing main image 140 (FIG. 2). In addition, frame buffer 184 includes an area for tile image data 188 for data describing tile image 150 (FIG. 3). Display interface 192 retrieves data during each frame refresh from frame buffer 184 and passes the data to display 200 in accordance with the timing and other requirements of display 200. Display interface 192 includes a memory controller 194 for reading image data from frame buffer 184 and passing the data as required to display controller 196, which generates timing signals and other control information necessary to cause display 200 to generate an image in the manner generally known.

Graphics controller 180 further includes a plurality of registers 190. As will be understood by those skilled in the art, registers 190 may be distributed throughout graphics controller, collected in a single register block, or integrated into frame buffer 184. As used herein, the term, “register” will therefore refer to a memory location containing a value controlling the operation of graphics controller 180. Registers 190 are addressable by host CPU 102, which can load registers 190 with values that control the operation of display interface 192. Table 1 shows exemplary values for registers 190, some of which are illustrated in FIGS. 2 and 5.

In one embodiment, the main image covers the entire display. However, it is also possible that a main display area can be selected so that the main image only covers a portion of the display. In this embodiment, values X₀ and Y₀ represent starting positions of the upper left corner of the main image 140 within display screen 120. The register values M_{W} and M_{H} identify the width and height, respectively, of main image 140. In one embodiment, the upper left corner of the display is identified as the origin, with the x- and y-coordinate values increasing to the right and down, respectively. However, any coordinate system can be implemented. Register values D_{W} and D_{H} identify the width and height of a display region. In one embodiment, register values D_{W} and D_{H} may hard-coded into display interface 192 or set by hard wiring output pins (not shown) of graphics controller 180 and therefore may not be programmable. In other embodiments, D_{W} and D_{H} may be programmable to enable display interface 192 to operate with a variety of different size displays or in different display modes.

Register values T_{W} and T_{H} identify the width and height, respectively, of tile image 150. X_{OFFSET} and Y_{OFFSET} define the offset amount of the tiled background as described above with reference to FIG. 5. Register values ΔX and ΔY identify the amount that the X_{OFFSET} and Y_{OFFSET} are incremented, respectively, with each frame n number of frame refreshes. Together, ΔX and ΔY identify the direction of movement of the animated background. For example, by setting ΔX to zero and ΔY to one, the overlay will scroll down only. A register value n allows for the speed of movement to be modified by changing the number of frame refreshes between each update of the overlay position. An exemplary device refreshes the display 30 times a second so that if n is equal to 1, X_{OFFSET} and Y_{OFSSET} are updated 30 times a second and if n is equal to 2, then X_{OFFSET} and Y_{OFFSET} would be updated 15 times a second. Lastly, the enable register value may be used to enable and disable display of the tiled background image.

TABLE 1

| Symbol | Description |
|---|---|
| X₀ | X - distance in pixels from left edge of the display to |
| | the left edge of the main image |
| Y₀ | Y - distance in pixels from the top edge of the display |
| | to the top edge of the main image |
| D_{W} | Display width |
| D_{H} | Display height |
| M_{W} | Main image width |
| M_{H} | Main image height |
| T_{W} | Tile image width |
| T_{H} | Tile image height |
| ΔY | Rise - Number of pixels to move tiled background |
| | vertically each n frame refreshes |
| ΔX | Run - Number of pixels to move tiled background |
| | horizontally each n frame refreshes |
| Transp. | Value of transparent pixel of main image |
| n | Speed - Number of frame refreshes between each |
| | X_{OFFSET}, Y_{OFFSET} update; a value of zero causing the |
| | tiled background to remain stationary |
| Enable | Enables or disables background tile generation |

It should be noted that other register values may be provided as would occur to those skilled in the art having the benefit of the present disclosure. In one embodiment, registers are provided for determining the format of the image data, i.e., the bit depth and encoding scheme. Registers can also be provided for identifying the starting location of the image data within frame buffer 184. Other registers may be provided to enable enhancements to the basic image compositing features described above. For example, a tile pattern register may be used to define the manner of tiling. For example, a value can be used to define an additional offset to each row or column. In this case, if the offset value is “2” then the second row will be offset by two more than the first row, the third row will be offset by two more than the second row, and so on. A negative value can denote a column offset instead of a row offset. The background tile animation may also be further enhanced using additional register values. For example, various patterns of movement such as circular, wavy, or random, can be hard-wired into display interface 192 and enabled using one or more additional register values in a manner that will be apparent to those skilled in the art having the benefit of the present disclosure.

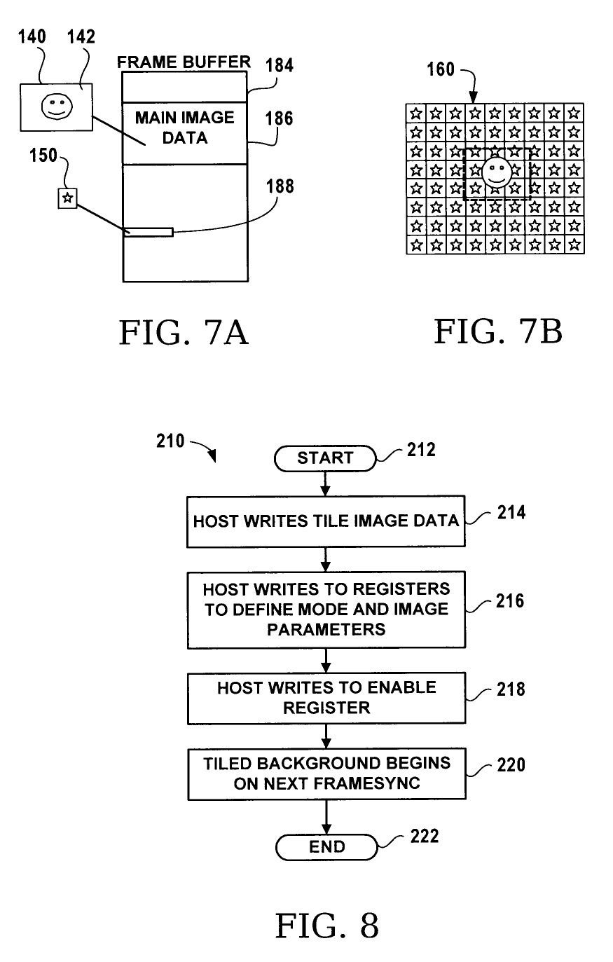

FIG. 7A shows an exemplary frame buffer 184 for storing image data. In this example, main image data 186 is stored in one region of frame buffer 184, and tile image data 188 is stored in another region of frame buffer 184. Main image data defines the appearance of main image 140 while tile image data 188 defines the appearance of tile image 150. It should be noted that only a single instance, or copy, of tile image data 188, which may represent only a single tile image, is required to be stored in frame buffer 184, the display interface being responsible for generating a repeating pattern from tile image 150. This reduces the amount of processing required by the host CPU as well as the volume of data transmitted to and stored in frame buffer 184. Composite image 160 shown in FIG. 7B is formed from main image 140 and tile image 150. In this example, main image 140 shows a smiley-face with a transparent background area 142 and tile image 150 is a star-shaped graphic. When combined, the smiley face overlies the repeated tile image 150, with the tile images 150 showing through the transparent region 142 of the main image 140.

FIG. 8 shows a flowchart diagram 210 illustrating exemplary procedure for causing a tiled background to be generated by graphics controller 180 of FIG. 6. The procedure begins as indicated by start block 212 and flows to operation 214 wherein host CPU 102 (FIGS. 1, 6) writes tile image data 188 to frame buffer 184. Then, in operation 216, host CPU 102 writes to the registers to define the tiling mode and image parameters, including tile image size and offset, and ΔX and ΔY animation parameters. Next, in operation 218, the host writes to the enable register to enable tile generation. In operation 220, the tiled background begins on the next framesync. The procedure then ends as indicated by end block 222. Those skilled in the art will recognize that, in addition to main image data, the tile image data and register values can be updated by the host CPU to modify the background and/or the animation. This can be used for various effects. For example, a side-scrolling flying game can allow an image of an airplane overlaying a tiled image of a sky with clouds. When the user presses an up-arrow button, the register can be updated to cause the sky to scroll downward, and when the user presses a down-arrow button, the register can be updated to cause the sky to scroll upward, thereby giving the effect of controlling an airplane as it flies across a continuous cloud-filled background.

FIG. 9 shows a simplified block diagram illustrating by way of example a hardware configuration for memory controller 194 of display interface 192 (FIG. 6). As mentioned previously, the memory controller retrieves image data from image buffer 184 and passes this image data to display controller 196, which drives the external display.

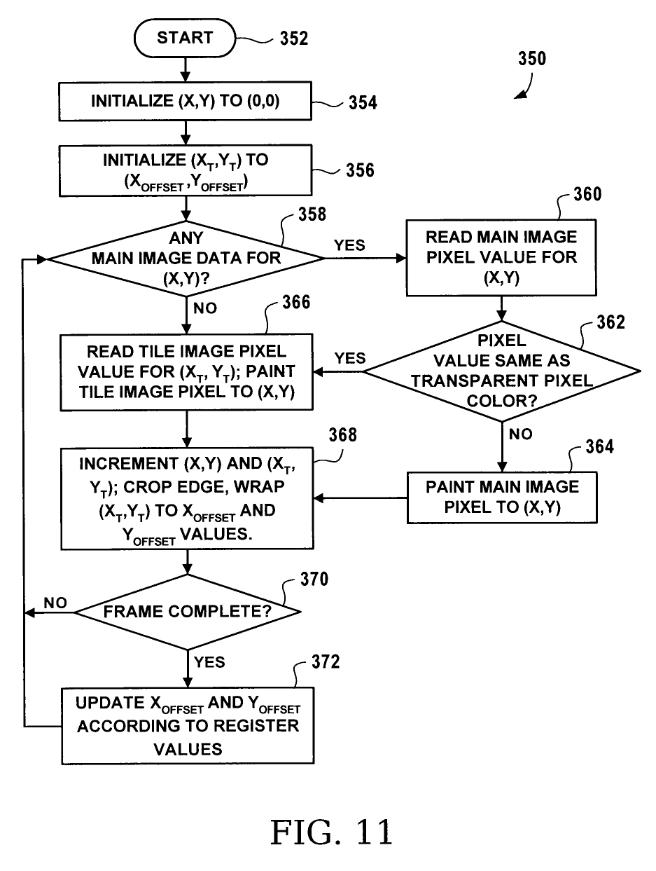

As mentioned previously, image data may be stored in a predetermined format, or in one of several predetermined formats. Depending upon the implementation, the image data stored in frame buffer 184 may be required to be converted into a format understandable by display 200 (FIGS. 1, 6). RGB converter 250 retrieves the next pixel value for the tile image and for the main image and places it in temporary registers 252, 254, respectively. Logic for calculating the memory location for the next pixels is not shown, however the procedure is described below with reference to FIG. 11. In one embodiment, the memory locations of next tile pixel value and the next main pixel value may depend on register values for the main and tile images' width and height, as well as any offset of the tile images. Scaling of the main image into the display screen can be done by skipping or duplicating certain pixels, thereby shrinking or enlarging the main image to fit a selected size main image area. Such scaling can be performed in response to scaling factors or other information provided in registers 190 (FIG. 6).

Logic 262 generates a select signal 269 to determine whether the next tile pixel value 252 or the next main pixel value 254 is passed to display controller 196 using multiplexer 270. The selection is made based on the coordinates of the next pixel to be painted to the display screen and/or the color of the corresponding main image pixel as described below. This logic can be implemented in many different ways without departing from the spirit and scope of the present invention as defined in the claims appended hereto. In one embodiment, the current position (X, Y) of the next pixel to be painted to display controller 196, stored in internal register 260 is compared with the position and size of the main image 258 using compare logic 266. If the current pixel (X, Y) is within the main image area, then a “1” value is output from compare logic 266, other wise a “0” value is output from compare logic 266. Compare logic 264 compares the transparent color value retrieved from registers 190 to next main pixel value 254, and outputs a “1” if the next main pixel value matches the transparent pixel value and a “0” if they are not matched. The outputs from compare logics 264, 266 are combined using logic gates 268 to generate select signal 269 which is input into multiplexer 270, which passes one of the tile pixel values or main pixel values, depending on the select signal. Those skilled in the art will recognize that other features not shown may be included. For example, in one embodiment, logic 262 compares a register containing an enable/disable value as described above with reference to Table 1 for disabling the tiled background generation.

FIG. 10 shows a flowchart 300 illustrating in simplified terms and by way of example the operation of logic 262. The procedure begins as indicated by start block 302 and proceeds to operation 304 wherein the current (X, Y) coordinates are compared with the size and position of the main image area to determine if it falls within the main image area. If the current (X, Y) coordinate does not fall in the main image area, then a tile pixel is to be displayed at that location and the procedure flows to operation 310 to forward the tile pixel value to display controller 196 (FIGS. 6, 9). However, if the current (X, Y) coordinate does fall within the main image area, then the procedure flows to operation 306 to determine whether the main image pixel at the current (X, Y) coordinate has a value that matches the selected transparent color value, which may be hardwired or stored in a register. If the main image pixel value matches the transparent color value, then the procedure flows to operation 310 to forward the tile pixel value, otherwise the procedure flows to operation 308 to forward the main pixel color value. After passing the appropriate pixel value in operations 310 or 308, the procedure ends as indicated by done block 312.

FIG. 11 shows a flowchart 350 illustrating by way of example a procedure carried out by display interface 192 of FIG. 6. The procedure begins as indicated by start block 352 and flows to operation 354 wherein (X, Y) is initialized to (0, 0). The coordinate pair (X, Y) indicates the next value to be passed to display 200 via display controller 196 (FIG. 6). The procedure then flows to operation 356, wherein (X_{T}, Y_{T}) is initialized to (X_{OFFSET}, Y_{OFFSET}), which is stored in registers 190. After initializing (X, Y) and (X_{T}, Y_{T}), the procedure flows to operation 358.

In operation 358, it is determined whether there is any main image data for coordinates (X, Y). This is determined by comparing the coordinates (X, Y) with the size and position of the main image to determine whether the current coordinates fall within the main image area of display screen 120 (FIG. 2). If there is no main image data at the current coordinates (X, Y), then the procedure flows to operation 366 wherein the tile image pixel value at (X_{T}, Y_{T}) is painted to the display screen at location (X, Y). However, if there is main image data at the current coordinates in operation 358, then the procedure flows to operation 360 wherein the main image pixel value for (X, Y) is retrieved. Then, in operation 362, the main image pixel value is compared with the transparent pixel color. If the main image pixel value matches the transparent image pixel color then the procedure flows to operation 366 to paint tile pixel (X_{T}, Y_{T}) to the display screen at location (X, Y). If the main image pixel does not match the transparent pixel color value in operation 362, then the procedure flows to operation 364 wherein the current main image pixel is painted to the output screen at location (X, Y).

From operations 366 and 364, the procedure flows to operation 368, wherein the current coordinate pairs (X, Y) and (X_{T}, Y_{T}) are updated. For X, Y, the value of X is incremented until it exceeds the width of display screen 120. When it exceeds the width of the display screen, it reverts to zero and Y is incremented by one. This continues until the bottom right pixel is addressed, whereupon X and Y are both reset to zero to begin a new frame at the top left corner of display screen 120. Likewise, (X_{T}, Y_{T}) are incremented in a similar manner, except Y_{T} is incremented when Y is incremented, and X_{T} is reset to the X_{OFFSET} AND Y_{T} is reset to Y_{OFFSET} each time X_{T} and Y_{T} exceed the width and height, respectively, of the tile image. After incrementing the values, the procedure flows to operation 370, wherein it is determined whether the frame is complete. If the frame is not complete, then the procedure returns to operation 358. If the frame is complete, then the procedure flows to operation 372, wherein tile offset values X_{OFFSET} and Y_{OFFSET} are updated according to ΔX and ΔY values, respectively, as stored in registers 190. After each complete frame, the tile offset values for the time image may be updated to create the animation effect of a scrolling background. If ΔX and ΔY are both zero, then no scrolling or updating of the tile offset values will occur. Custom animations, e.g., to provide a circular or wavy motion to the tiled background image can be achieved by setting the offset values according to a table which may be hard-wired or programmed by the host CPU. After any updating of the tile offset values in operation 370, the procedure returns to operation 358 to begin painting the next frame.

It will be recognized by those skilled in the art that the procedures outlined above with reference to FIGS. 10 and 11 are performed in hardware using logic gates, and therefore not necessarily sequentially as might be suggested by the flowcharts. Thus, many operations may be performed in parallel and/or in a different order than presented above. Furthermore, there may be instances where a particular operation is combined with other operations such that no intermediary state is provided. Likewise, various operations may be split into multiple steps with one or more intermediary states. Graphics controller 180 (FIG. 6) and other hardware devices incorporate logic typically designed using a hardware description language (HDL) or other means known to those skilled in the art of integrated circuit design. The generated circuits will include numerous logic gates and connectors to perform various operations and does not rely on software instructions.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A graphics controller, comprising:
a host interface for communicating with an external host CPU;
an image memory in communication with the host interface, the image memory being configured to store main image data and tile image data, the main image data defining a main image and the tile image data defining a tile image;
a plurality of registers in communication with the host interface; and
logic circuitry configured to select between the tile image data and the main image data when passing pixel values to a display controller, the logic circuitry generating a composite output image having the main image overlying a tiled background image containing multiple copies of the tile image.

2. The graphics controller of claim 1, wherein the logic circuitry is configured to position the tiled background image at an X_{OFFSET} and a Y_{OFFSET}, the X_{OFFSET} being a number of pixels that the tiled background image is shifted horizonatally, and the Y_{OFFSET} being a number of pixels that the tiled background image is shifted vertically

3. The graphics controller of claim 2, wherein:
the registers include a ΔX value, a ΔY value, and an n value; and
the logic circuitry is configured to increment X_{OFFSET} by ΔX and increment Y_{OFFSET} by ΔY every n frame refreshes, thereby animating the tiled background image.

4. The graphics controller of claim 1, wherein:
the logic circuitry is configured to select a pixel value from the tile image data when a current main image pixel value matches a transparent color value.

5. The graphics controller of claim 4, wherein the transparent color value is stored in one of the registers.

6. The graphics controller of claim 1, wherein the graphics controller is integrated into a battery operated device incorporating the external host CPU, the battery operated device further including a graphical display having a two dimensional matrix of pixels.

7. A hardware-implemented method for generating a composite image from a main image and a tile image, the method comprising:
receiving tile image data into an image buffer, the tile image data comprising a plurality of tile image pixel values that define a tile image;
receiving main image data into the image buffer, the main image data comprising a plurality of main image pixel values defining a main image;
receiving register values into a plurality of registers;
determining whether a pixel to be painted to a display screen should be taken from the tile image data or the main image data, the determining being based at least in part on the register values;
passing one of the tile image pixel values from the tile image data to the display screen when the pixel to be painted should be taken from the tile image data, the tile image pixel value being selected so that multiple copies of the tile image is generated in the display screen from the tile image data; and
passing one of the main image pixel values from main image data to the display screen when the pixel to be painted should be taken from the main image data.

8. The method of claim 7, wherein the determining of whether a pixel to be painted to the display screen should be taken from the tile image data or the main image data is made by comparing register values defining a position and size of a main image display area, the main image display area being a region within the display screen in which the main image is displayed; wherein when the pixel to be painted lies within the main image display area, one of the main image pixel values is passed to the display screen and when the pixel to be painted lies outside of the main image display area, one of the tile image pixel values is passed to the display screen.

9. The method of claim 7, wherein the determining of whether a pixel to be painted to the display screen should be taken from the tile image data or the main image data is made by comparing a main image pixel value to be passed to the display screen with a transparent color value, passing the main image pixel value to the display screen when the main image pixel value is not equal to the transparent color value, and passing the tile image pixel value to the display screen when the main image pixel value is equal to the transparent color value.

10. The method of claim 7, wherein the determining of whether a pixel to be painted to the display screen should be taken from the tile image data or the main image data comprises:
comparing the coordinates of the pixel to be painted to the display screen with coordinates and size of a main image area, the coordinates and size of the main image area being defined in by the register values, and passing a main image pixel value from the main image data when the coordinates of the pixel to be painted is outside the main image area;
when the coordinates of the pixel to be painted is inside the main image area, comparing the main image pixel value with a transparent color value, passing the main image pixel value to the display screen when the main image pixel value is not equal to the transparent color value, and passing the tile image pixel value to the display screen when the main image pixel value is equal to the transparent color value.

11. The method of claim 10, further comprising reading the transparent color value from the registers.

12. The method of claim 7, wherein the tile image pixel value being selected so that multiple copies of the tile image is generated in the display screen at an offset defined by an X_{OFFSET} value and a Y_{OFFSET} value stored in the registers, the multiple copies of the tile image forming a tiled background image, the X_{OFFSET} value defining a number of pixels the tiled background image is shifted horizontally, and the Y_{OFFSET} value defining a number of pixels the tiled background image is shifted vertically.

13. The method of claim 12, wherein the registers further comprise a ΔX value, a ΔY value, and an n value, the n value defining a number of frame refreshes between updates of the X_{OFFSET} and Y_{OFFSET} values, the X_{OFFSET} value being updated by setting X_{OFFSET} equal to the sum of the ΔX and X_{OFFSET} values, and the Y_{OFFSET} being updated by setting Y_{OFFSET} equal to the sum of the ΔY and Y_{OFFSET} values.

14. The method of claim 13, wherein, when n is zero, then X_{OFFSET} and Y_{OFFSET} are not updated.

15. A method for causing a graphical controller to composite a main image over a tiled background image, the method comprising:
writing tile image data to a frame buffer of the graphical controller;
writing to registers of the graphical controllers, the registers defining a display mode and image parameters; and
writing a value to an enable register, wherein the value written to the enable register causing the graphical controller to generate the tiled background image by repeating a tile image defined by the tile image data.

16. The method of claim 15, further comprising:
writing main image data to the frame buffer, the main image data defining the main image that is composited with the tiled background image.

17. The method of claim 15, wherein the writing to the registers includes writing an X_{OFFSET} value and a Y_{OFFSET} value, the X_{OFFSET} value defining a number of pixels that the tiled background image is shifted in a horizontal direct and the Y_{OFFSET} value defining a number of pixels that the tiled background image is shifted in a vertical direction.

18. The method of claim 17, wherein the the writing to the registers further comprises writing a ΔX value, a ΔY value, and an n value to the registers, the ΔX value defining a number of pixels added to the X_{OFFSET} value every n frame refreshes and the ΔY value defining a number of pixels added to the Y_{OFFSET} value every n frame refreshes.
